(19) United States
(12) Patent Application Publication
(10) Pub. No.: US 2007/0205309 A1
(43) Pub. Date: Sep. 6, 2007

(54) Revolving Adapter For Shower Head

(76) Inventor: Huasong Zhou, Xiamen, Fujian (CN)

Correspondence Address: BANGER SHIA, 204 CANYON CREEK, VICTORIA, TX, 77901-3695, US

(21) Appl. No.: 11/307,986

(22) Filed: Mar. 1, 2006

(51) Int. Cl. B05B 15/08

(52) U.S. Cl. 239/587.1; 239/587.5; 239/588

(57) ABSTRACT

The present invention provides a revolving adapter for shower head, which is typically comprised of an enclosure, a baffle disk, an impeller, a main body, a shaft, a union nut and seal loops; wherein, said enclosure has an opened downward cavity, and a universal piping segment extended out upward from the closed top end for connecting to the inlet pipe; said main body is configured to an end cover securing on the opening of the cavity of the enclosure for sealing, and has a through-hole at the closed end, and extends a collar upward stretching into the cavity of the enclosure to form a water cell with proper number of beveled holes built upon the side wall; said impeller contained at the inside of the water cell of the main body includes blades facing to the beveled holes respectively, so that water shot into the water cell from the outside via said beveled holes shoot on the surfaces of said blades to drive the impeller span; said shaft is mounted over the through-hole of the end cover, and sealed with said seal loop on the contact surface with the through-hole, the tip end of the shaft extended into the inside of the water cell is used for fitting on said impeller in fix connection, the another end of the shaft is used for connecting to the conventional shower head. The present invention can be used as accessories of all shower heads for obtaining auto-revolving water flow as showing with high versatility and wider conformability.

### BACKGROUND OF THE INVENTION

1. Field of the Invention

The present invention relates to a water conveyance system used for connecting to shower head, and more particularly to a revolving adapter for conveying water to the shower head and revolving it.

2. Description of Prior Art

In accordance with the conventional technology, most of the shower heads are divided into hand-hold and hang-up on the wall, and so on. Commonly, swiveling the shower head as necessary is carried out by hand, either directly use hand holds to operate, or leave hands to turn the shower head specially, so both of them are performed by hands, it is not enable to be carried out automatically, the operation is inconvenient with poor effect of spraying water.

For resolving these problems, the U.S. Pat. No. 5,704,547 discovered an auto-revolving shower heads, in which an impeller is attached on for outputting revolving water flow by spanning the same. But, said invention is regarded to change the whole construction of the shower head, just as by spanning one part at the inside of the shower head, therefore, it is not suit to wider application, especially to the legacy shower heads having to be replaced as changing to the revolving water flow, so it not only increases the research cost, but increase the production cost as well.

Even if the auto-revolving shower head comes out by researching and manufacturing, the customers have to pay extra more for replacing the legacy, although the legacy still can be used well, so it is undoubtedly a kind of extravagant spend.

For this sake, the inventor researched and developed a revolving adapter to all shower head for obtaining revolving water flow without changing the construction of the legacy shower head in time, so that the user just attaches the revolving adapter between the outlet of the inlet pipe and the inlet of the legacy shower head, then enjoy the auto-revolving water flow with lower payment simply and conveniently.

### OBJECTS AND SUMMARY OF THE INVENTION

It is therefore a main object of the present invention to provide a revolving for adapter for shower head performing as common accessories of shower head, facilitating to auto-revolving the legacy shower head to obtain revolving water flow improving the spraying water effect.

For achieving the above-mentioned object, the present invention provides a revolving adapter for shower head typically comprised of an enclosure, a baffle disk, an impeller, a main body, a shaft, a union nut and seal loops; wherein, said enclosure has an opened downward cavity, and a piping segment extended out upward from the closed top end for connecting to the inlet pipe; said main body is configured to an end cover securing on the opening of the cavity of the enclosure for sealing, and has a through-hole at the closed end, and extends a collar upward stretching into the cavity of the enclosure to form a water cell with proper number of beveled holes built upon the side wall; said impeller contained at the inside of the water cell of the main body includes blades facing to the beveled holes respectively, so that water shot into the water cell from the outside via said beveled holes shoot on the surfaces of said blades to drive the impeller span; said shaft is mounted over the through-hole of the end cover, and sealed with said seal loop on the contact surface with the through-hole, the tip end of the shaft extended into the inside of the water cell is used for fitting on said impeller in fix connection, the another end of the shaft is used for connecting to the conventional shower head.

Said seal loop is configured into “Y”-shaped cross section.

As utilizing above-mentioned project, the revolving adapter provided by the present invention is a common adapter used to connect the pipe to the conventional shower head, so the common connection pipe and common joint are both in size as same as common, just as the present invention can connect to the conventional pipe and shower head at free directly, therefore, the present invention can be used as accessories of all shower heads with high versatility and wider conformability.

In using, water enters the cavity of the enclosure via the piping segment from the inlet pipe, running against the baffle disk, passing by it into the water cell from the beveled holes distributed on the collar wall respectively, then shoot on the surfaces of the blades of the impeller to drive the impeller span, by means of the shaft holding the impeller and the conventional shower head with the both ends, the shower head is revolved simultaneously, to get revolving water flow as showing conveniently.

The main difference between the present invention and the U.S. Pat. No. 5,704,547 is that a revolving adapter is used to replace a rotation part built on the inside of the enclosure of the U.S. Pat. No. 5,704,547. Therefore, the legacy shower heads will be not replaced or changed in structure, the research cost and the production cost are both gone down, and building a new revolving water conveyance system is so easy and convenient that every customer can afford it.

### BRIEF DESCRIPTION OF THE DRAWINGS

FIG. 1 is an exploded view of the present invention.

FIG. 2 is a cross-section view of the present invention.

FIG. 3 is a side view showing using in the top side location of the present invention.

FIG. 4 is a side view showing using in the wall side location of the present invention.

FIG. 5 is a side view showing using in hand-hold of the present invention.

### DETAILED DESCRIPTION OF PREFERRED EMBODIMENTS

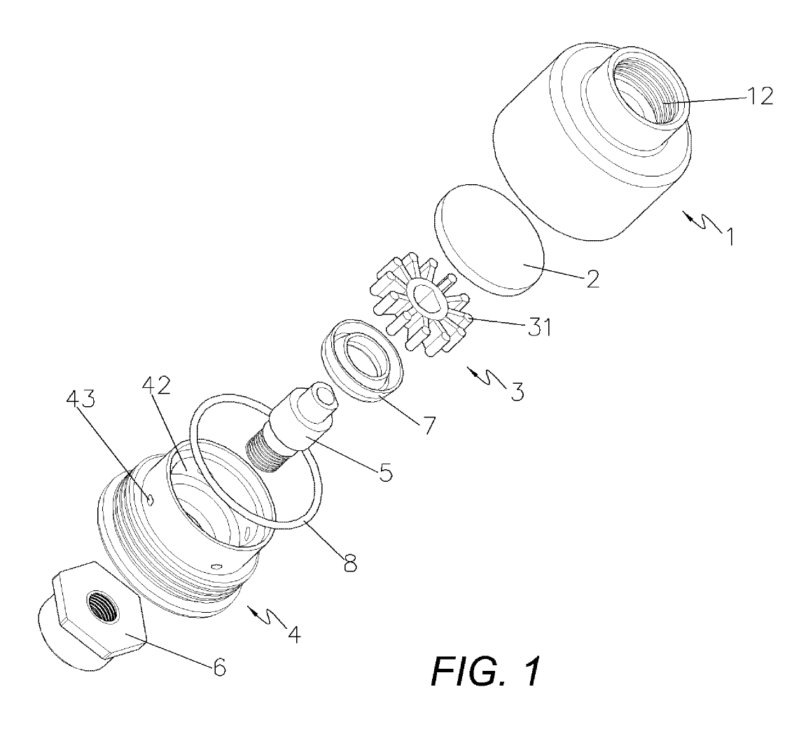

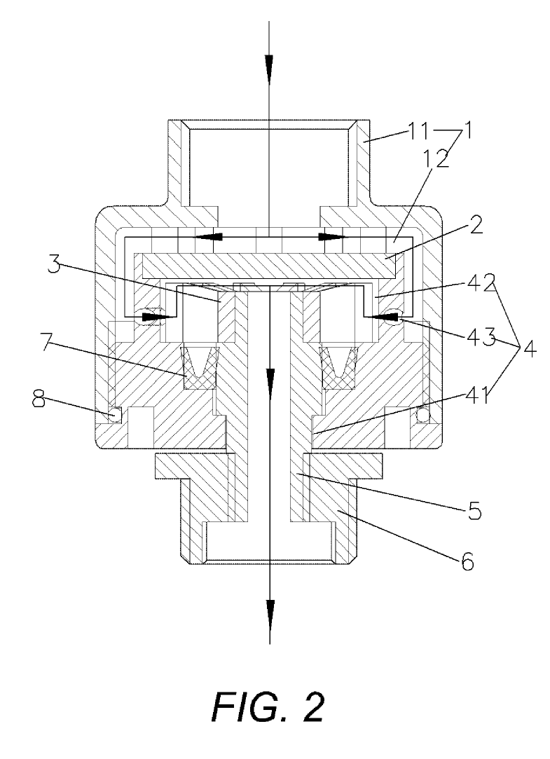

Referring to FIG. 1 and FIG. 2, a revolving adapter for shower head discovered by the present invention is typically comprised of an enclosure 1, a baffle disk 2, an impeller 3, a main body 4, a shaft 5, a union nut 6 and seal loops 7 and 8.

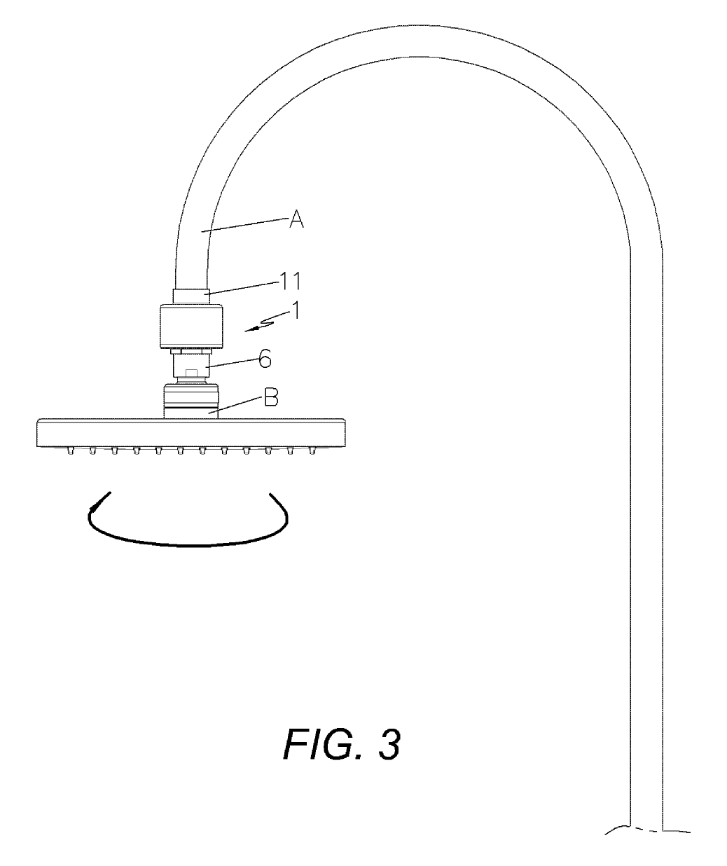

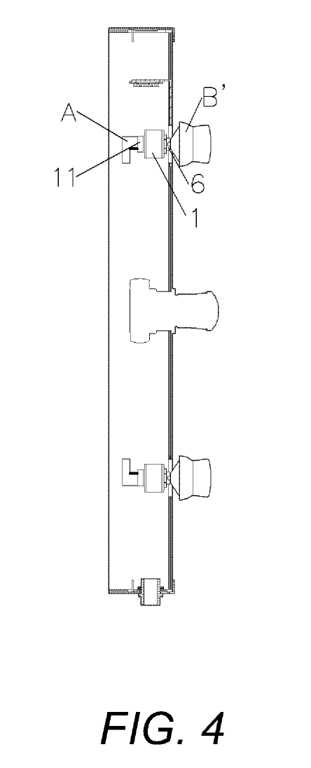

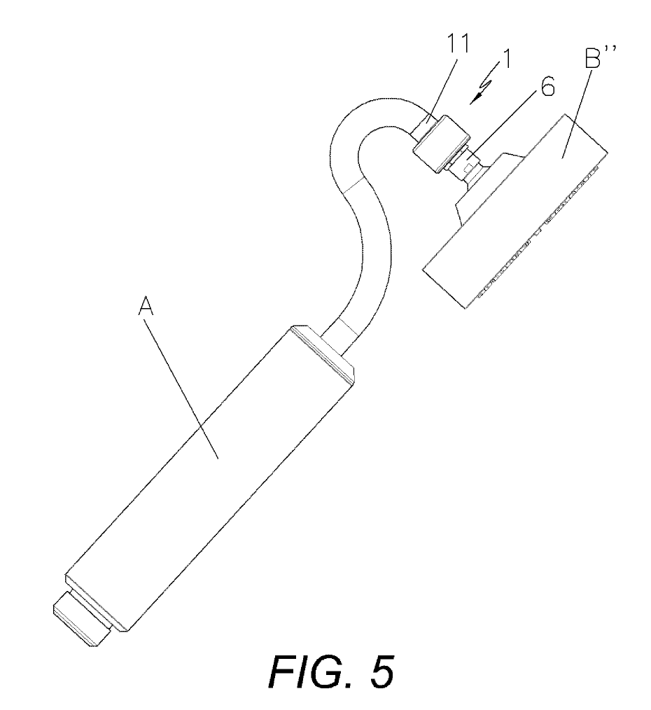

Said enclosure 1 has an opened downward cavity 11, and a piping segment 12 extended out upward from the closed top end for connecting to the common inlet pipe A (as shown in FIG. 3 to FIG. 5).

Said main body 2 is configured to an end cover securing on the opening of the cavity 11 of the enclosure 1 for sealing, and has a through-hole 41 at the closed end, and extends a collar upward stretching into the cavity 11 of the enclosure 1 to form a water cell 42 with proper number of beveled holes 43 built upon the side wall.

Said baffle disk 2 is a cap covering over the water cell 42.

Said impeller 3 contained at the inside of the water cell 42 of the main body 4 includes blades 31 facing to the beveled holes 43 respectively, so that water shot into the water cell 42 from the outside via said beveled holes 43 shoot on the surfaces of said blades 31 to drive the impeller span.

Said shaft 5 is mounted over the through-hole 41 of the end cover of the main body 4, and sealed with said seal loop 7 on the contact surface with the through-hole 41; said seal loop 7 is configured into “Y”-shaped cross section such as a “Y” sealing ring. The tip end of the shaft 5 extended into the inside of the water cell 42 is used for fitting on said impeller 3 in fix connection, another end of the shaft 5 hang at outside is used for connecting to the conventional shower head B B′ B″ in common connection (as shown in FIG. 3 to FIG. 5).

All the matching surfaces of the adjacent components should be sealed with O-rings, just as the joint portion between the main body 4 and the opening of the cavity 11 of the enclosure 1 is sealed with an O-ring 8.

For connecting to common inlet pipe and shower head, the piping segment 12 and the union nut 6 are designed in common size coordinating to the conventional standard, in order to make the present invention perform as a common accessory of all conventional shower heads with high versatility and wider conformability, as shown in FIG. 3 to FIG. 5, by means of the piping segment 12 and the union nut 6, the present invention is mounted between the inlet pipe A and the shower head B B′ B″. In using, water enters the cavity 11 of the enclosure 1 via the piping segment 12 from the inlet pipe A, running against the baffle disk 2, passing by it into the water cell 42 from the beveled holes 43 distributed on the collar wall respectively, then shoot on the surfaces of the blades 31 of the impeller 3 to drive the impeller 3 span, by means of the shaft 5 holding the impeller 3 and the conventional shower head B with the both ends, the shower head B is revolved simultaneously, to get revolving water flow as showing conveniently.

The key feature of the present invention is that the individual revolving water conveyance apparatus is suit to connect the common conventional accessories, in this case, when it is attached between the inlet pipe and the shower head, the shower head can be revolved whole for obtain revolving water flow, instead of the rotation part built in the U.S. Pat. No. 5,704,547. based on this principle, the development cost of the present invention goes down greatly due to not involving to the inside structure of the conventional shower head, further to decrease consumption cost and extra spend, especially to the huge amount of users having the legacy shower heads (without revolving water flow function), after selecting the present invention and attaching it between the inlet pipe and the legacy shower head, joy revolving water flow rapidly, meanwhile avoid extra spending.

What is claimed is:

1. A revolving adapter for shower head typically comprised of an enclosure, a baffle disk, an impeller, a main body, a shaft, a union nut and seal loops; wherein, said enclosure has an opened downward cavity, and a universal piping segment extended out upward from the closed top end for connecting to the inlet pipe; said main body is configured to an end cover securing on the opening of the cavity of the enclosure for sealing, and has a through-hole at the closed end, and extends a collar upward stretching into the cavity of the enclosure to form a water cell with proper number of beveled holes built upon the side wall; said impeller contained at the inside of the water cell of the main body includes blades facing to the beveled holes respectively, so that water shot into the water cell from the outside via said beveled holes shoot on the surfaces of said blades to drive the impeller span; said shaft is mounted over the through-hole of the end cover, and sealed with said seal loop on the contact surface with the through-hole, the tip end of the shaft extended into the inside of the water cell is used for fitting on said impeller in fix connection, the another end of the shaft is used for connecting to the conventional shower head.

2. A revolving adapter for shower head typically comprised of an enclosure, a baffle disk, an impeller, a main body, a shaft, a union nut and seal loops; wherein, said enclosure has an opened downward cavity, and a piping segment extended out upward from the closed top end for connecting to the inlet pipe; said main body is configured to an end cover securing on the opening of the cavity of the enclosure for sealing, and has a through-hole at the closed end, and extends a collar upward stretching into the cavity of the enclosure to form a water cell with proper number of beveled holes built upon the side wall; said impeller contained at the inside of the water cell of the main body includes blades facing to the beveled holes respectively, so that water shot into the water cell from the outside via said beveled holes shoot on the surfaces of said blades to drive the impeller span; said shaft is mounted over the through-hole of the end cover, and sealed with said seal loop on the contact surface with the through-hole, said seal loop is configured into “Y”-shaped cross section such as a “Y” sealing ring, the tip end of the shaft extended into the inside of the water cell is used for fitting on said impeller in fix connection, the another end of the shaft is used for connecting to the conventional shower head.
